(19) United States
(12) Patent Application Publication
(10) Pub. No.: US 2013/0202498 A1
(43) Pub. Date: Aug. 8, 2013

(54) Catalytic Reactor and Catalyst Structure

(71) Applicants: Neil Maxted, East Yorkshire (GB); Robert Peat, Longcot (GB); Ross Alexander Morgan, Witney (GB)

(72) Inventors: Neil Maxted, East Yorkshire (GB); Robert Peat, Longcot (GB); Ross Alexander Morgan, Witney (GB)

(73) Assignee: CompactGTL Limited, Redcar, Cleveland (GB)

(21) Appl. No.: 13/878,000

(22) PCT Filed: Oct. 3, 2011
(86) PCT No.: PCT/GB2011/051874

§ 371 Date: Apr. 5, 2013

(30) Foreign Application Priority Data
Oct. 7, 2010 (GB) 1016926.6

(51) Int. Cl. B01J 8/00

(52) U.S. Cl. CPC B01J 8/008
USPC 422/219; 422/310

(57) ABSTRACT

A reactor defines first and second flow channels within the reactor, the first flow channels and the second flow channels extending in parallel directions along at least the major part of their lengths. A removable non-structural catalyst insert is provided in those channels in which a reaction is to occur, the catalyst insert comprising a plurality of foils bonded together and which subdivide the flow channel into a multiplicity of flow sub-channels. At least one end portion of the catalyst insert is devoid of active catalytic material. The end portion that is devoid of active catalytic material suppresses the reaction in that part of the flow channel, and so reduces the requirement for any thermal transfer at that part of the flow channel.

The present invention relates to a reactor for performing chemical reactions which involve heat transfer, the reactor defining channels in which there is a catalyst structure, and to a catalyst structure for use in such a reactor.

The use of a catalytic reactor consisting of a stack of metal sheets that define first and second flow channels, where catalyst is provided on removable inserts such as corrugated foils within the flow channels, is described for example in WO 03/033131, which describes use of such a reactor for performing various chemical reactions for example Fischer-Tropsch synthesis, steam methane reforming, or combustion. WO 2010/067097 also describes a catalytic reactor in which a catalyst insert may comprise one or more corrugated foils. The two sets of channels enable heat transfer to take place between the contents of those channels. For example steam methane reforming is an endothermic reaction that requires an elevated temperature, typically above 750° C.; and the requisite heat may be provided by a combustion reaction taking place in the other set of channels within the catalytic reactor. Fischer-Tropsch synthesis is an exothermic reaction, so in this case the channels adjacent to those for the synthesis reaction may carry a coolant.

Not only do thermal gradients within a reactor tend to lead to stresses within the material forming a reactor, but there is also a further risk of thermal runaway. With some exothermic catalytic reactions the rate of reaction may increase as the temperature increases; and in such a case there is a positive feedback between the reaction rate and the temperature within the reactor. This can lead to a rapid increase of temperature, referred to as a thermal runaway, and this can result in damage to the catalyst or to the reactor, or both, and would reduce the useful life of the reactor. Localised hotspots are also detrimental to the consistent operation of the reactor.

The provision of removable catalyst-carrying inserts in a reactor of the type described above is advantageous in that it enables the lifespan of the reactor to exceed the lifespan of the catalyst, potentially by several times. However, in order to deploy fresh catalyst into the reactor, the inserts must be removed and fresh inserts inserted. In order to facilitate easy catalyst exchange, it would be preferable to minimise the number of separate pieces that must be inserted into the reactor.

According to one aspect of the present invention there is provided a reactor defining first and second flow channels within the reactor, the first flow channels and the second flow channels extending in parallel directions along at least the major part of their lengths, with a removable catalyst insert provided in those channels in which a reaction is to occur, the catalyst insert comprising a plurality of foils bonded together and which subdivide the flow channel into a multiplicity of flow sub-channels, and wherein at least one end portion of the catalyst insert is devoid of active catalytic material.

Although mention has been made of there being first and second flow channels, for first and second fluids, it will be appreciated that the reactor might define flow channels for more than two different fluids.

The end portion that is devoid of active catalytic material suppresses the reaction in that part of the flow channel, and so reduces the requirement for any thermal transfer at that part of the flow channel. This is particularly advantageous where the first or second flow channels include inlet or outlet portions that connect to an inlet or outlet port or to a header, and extend in a direction that is not parallel to the direction of the major part of the length of the flow channel. Preferably active catalytic material is provided only on those portions of the catalyst insert that locate in a region of the reactor in which the first and second flow channels extend in parallel directions.

The catalyst inserts in at least one set of flow channels may be slightly longer than the length of those flow channels, so as to protrude from an end of the flow channel. Preferably the protruding length is no more than 20 mm, more preferably no more than 10 mm, for example 5 mm. This protruding length may make subsequent removal of the catalyst insert easier.

A preferred material for the foils is a high-temperature corrosion-resistant steel alloy, for example an aluminium-containing ferritic steel, in particular of the type known as Fecralloy (trade mark) which is iron with up to 20% chromium, 0.5-12% aluminium, and 0.1-3% yttrium. For example it might comprise iron with 15% chromium, 4% aluminium, and 0.3% yttrium. When this metal is heated in air it forms an adherent oxide surface of alumina which protects the alloy against further oxidation. This oxide surface layer also protects the alloy against corrosion under conditions that prevail within for example a methane oxidation reactor or a steam/methane reforming reactor. Where this metal is used as a catalyst substrate, and is coated with a ceramic coating into which a catalyst material is incorporated, the alumina surface on the metal is believed to bind with the ceramic coating, so ensuring the catalytic material adheres to the metal substrate.

Such alloy materials may not be readily available in suitable lengths. For example the total length of catalyst insert within a flow channel may be greater than 500 mm, for example 600 mm or 800 mm. This may consist of a plurality of discrete inserts placed end to end, or alternatively each flow channel may contain a single insert. The insert may comprise a stack of foils at least some of which are corrugated, each layer of the stack comprising lengths of foil arranged end to end, wherein in successive layers the positions at which ends of foils meet are staggered. This avoids the need for the foils arranged end to end to be bonded directly to each other, as they are connected by being bonded to the successive foil or foils in the stack. The foils may be bonded together by brazing; and may be bonded together along the entire length of each peak of the corrugations. Alternatively they may be welded, for example by spot welding.

For an insert length of 800 mm, preferably at least 600 mm is provided with catalyst, so the portion without catalyst is no greater than 200 mm; that is to say the portion without catalyst is no more than 25% of the total length. For example there might be 100 mm portions at each end that are devoid of catalyst, or there might be a 200 mm portion at one end.

Where the foils are corrugated, the corrugations may be square or rectangular in cross-section; or arcuate or sinusoidal; or they may be of zigzag shape, defining triangular corrugations, or a sawtooth shape, for example with sloping portions connected by flat peaks. The corrugations typically run parallel to the length of the foils. In some alternative configurations, the corrugations may be non-parallel or even perpendicular to the length of the foil. If the corrugations are provided at an acute angle to the length of the foil, with successive corrugated foils having the corrugations in mirror image orientations, then the gas will flow transversely across the channel, thereby reducing the lateral and vertical temperature variations by enabling mixing between the levels within the stack of foils as the reactants traverse the channel along alternately oriented flow paths. At least some of the foils may be perforated.

If the corrugated foils have corrugations that would enable adjacent foils to intermesh then the corrugated foils may be spaced apart by foils that are flat or substantially flat, to ensure they do not intermesh. Such flat foils are not necessary if the adjacent foils have corrugations that are not parallel. The flat foils may also be corrugated at a very small amplitude, for example to provide a total height of less than about 0.2 mm, for example 0.1 mm, as this makes them slightly less flexible and so easier to work with during assembly. The direction of the corrugations of the substantially flat foil may lengthwise along the foil or, alternatively, may be transverse. The shape of the corrugations of the flat foils may be sawtooth or rippled. The foils are preferably of thickness in the range 20-150 microns, for example 50 microns. A thicker foil, for example 100 microns thick, may provide benefits in enhanced heat transfer. By preventing intermeshing of the corrugated foils, for example by the provision of flat foils or by the provision of adjacent foils with non-parallel corrugations, the height of the insert is more repeatable and controllable than a stack in which identical corrugated foils are deployed.

A catalyst insert may therefore comprise a stack of corrugated foils (c) and substantially flat foils (f) that are bonded together. The stack may have corrugated foils as the outermost layers, or may have substantially flat foils as the outermost layers. A stack with corrugated foils as the outermost layers tends to be slightly more flexible than one with flat foils, and provides enhanced heat transfer to the wall of the channel, although a stack with flat foils as the outermost layers provides greater surface area for catalyst. Furthermore, if the outermost foil has corrugations, whether of small or large amplitude, the surface area that interfaces with the wall of the reactor channel during the insertion of the catalyst insert is reduced, and this may reduce the friction and resistance to the insertion of the insert.

By way of example, inserts may have the configurations fcfcfcfcf (i.e. 5 flat foils spaced apart by 4 corrugated foils); or cfcfcfc (i.e. 4 corrugated foils separated by 3 flat foils), or cfc (i.e. 2 corrugated foils separated by a flat foil).

To form the catalyst insert the foil structure would be provided with a catalytic material on at least part of its surface. For example it may be coated with ceramic support material, for example based on alumina, and this would be impregnated with active catalytic material appropriate for the reaction that is to take place in the corresponding channel. The ceramic coating may be applied by techniques such as dip coating, or spraying, to achieve a ceramic thickness between 10 microns and 100 microns, depending on the reaction, and the coating may be applied to separate foils before they are assembled into the catalyst insert, or after the foils have been bonded together. Some of the foils, or some of the surfaces of the foils, may be masked during the deposition of the ceramic coating. If the configuration of the foils is one with flat foils at the outside, the outer surface of the outer flat foils may be coated with ceramic and provided with active catalytic material, as there may be a narrow gap between the outer surface and the wall of the channel which would otherwise provide a bypass for the reactant gases; however if the foil insert is a tight fit in the channel, then the outer surface may be left uncoated, as this provides metal-to-metal contact with the wall of the channel and so enhances heat transfer to the wall.

Some of the foils may be devoid of catalyst. In particular it may be desirable to leave some sub-channels devoid of catalyst, to allow some gases to bypass the catalyst insert, for use downstream. The provision of an un-coated foil near the centre of a stack of foils forming an insert has the benefit of reducing the reaction rate in the vicinity of the centre of the insert, and so reducing the heat generation rate where the temperature will be at its highest, in the context of an exothermic reaction, or reducing the heat removal rate where the temperature is at its lowest, in the context of an endothermic reaction. In any event the catalytic coatings may differ between different foils, or between different sub-channels, or may differ along the length of the catalyst insert.

Within the reactor the first and second flow channels may be defined by grooves in plates arranged as a stack, or by spacing strips and plates in a stack, the stack then being bonded together. Alternatively the flow channels may be defined by thin metal sheets that are castellated and stacked alternately with flat sheets; the edges of the flow channels may be defined by sealing strips. The stack of plates forming the reactor is bonded together for example by diffusion bonding, brazing, or hot isostatic pressing. The stack of plates provides the requisite structure to ensure that the reactor can resist the differential pressures and thermal stresses that are applied during operation; the catalyst insert does not to provide structural support.

The channels may be square in cross-section, or may be of height either greater than or less than the width; the height refers to the dimension in the direction of the stack, that is to say in the direction for heat transfer. To ensure the good thermal contact both the first and the second flow channels may be between 20 mm and 1 mm high; and each channel may be of width between about 1.5 mm and 150 mm. By way of example the plates (in plan view) might be of width in the range 0.05 m up to 1 m, and of length in the range 0.2 m up to 2 m, and the flow channels are preferably of height between 2 mm and 10 mm (depending on the nature of the chemical reaction). For example the plates might be 0.5 m wide and 1.0 m long, or 0.6 m wide and 0.8 m long; and they may define channels 7 mm high and 6 mm wide, or 3 mm high and 10 mm wide, or 10 mm high and 5 mm wide. Arranging the first and second flow channels to alternate in the stack helps ensure good heat transfer between fluids in those channels. For example the first flow channels may be those for combustion (to generate heat) and the second flow channels may be for steam/methane reforming (which requires heat). The catalyst inserts are inserted into the channels, and can be removed for replacement.

Such reactors can be used for a variety of reactions including Fischer-Tropsch, and synthesis gas generation, for example by steam methane reforming. If the desired reaction is exothermic, adjacent channels may be provided with coolant to draw the heat of the reaction out of the reactor. Conversely, if the desired reaction is endothermic then heat must be provided to the flow channels. This may be achieved either by flowing hot fluids, preferably gases, through the channels or by undertaking an exothermic reaction in the adjacent channels. Catalytic combustion may be used to provide heat, and in this case a flame arrestor is preferably provided at the inlet to each flow channel for combustion to ensure a flame cannot propagate back into the combustible gas mixture being fed to the combustion channel. This may be within an inlet part of each combustion channel, for example in the form of a non-catalytic insert that subdivides a portion of the combustion channel adjacent to the inlet into a multiplicity of narrow flow paths which are no wider than the maximum gap size for preventing flame propagation. For example such a non-catalytic insert may be a longitudinally-corrugated foil or a plurality of longitudinally-corrugated foils in a stack. However, where the combustible gas is supplied through a header, then such a flame arrestor is preferably provided within the header.

In another aspect the present invention provides a reactor defining first and second flow channels within the reactor, the first flow channels and the second flow channels extending in parallel directions along at least the major part of their lengths, with a removable catalyst insert provided in those channels in which a reaction is to occur, the catalyst insert comprising a plurality of foils bonded together and which subdivide the flow channel into a multiplicity of flow sub-channels, wherein catalyst inserts in at least one set of flow channels are slightly longer than the length of those flow channels, so as to protrude from an end of the flow channel. The protruding length is preferably no more than 20 mm, more preferably no more than 10 mm.

In yet another aspect the present invention provides reactor defining first and second flow channels within the reactor, with a removable catalyst insert provided in those channels in which a reaction is to occur, the catalyst insert comprising a plurality of foils bonded together and which subdivide the flow channel into a multiplicity of flow sub-channels, wherein each catalyst insert comprises a stack of foils at least some of which are corrugated, and wherein at least some of the layers of the stack comprise lengths of foil arranged end to end. Preferably in the stack there are adjacent layers each comprising lengths of foil arranged end to end, and the positions at which ends of foils meet in those adjacent layers are staggered.

The invention also provides a reactor defining first and second flow channels within the reactor, with a removable catalyst insert provided in those channels in which a reaction is to occur, wherein each catalyst insert comprises a bonded stack of foils all of which are corrugated, wherein the corrugations in foils of alternate layers of the stack extend in different orientations.

In a further aspect, the present invention provides a catalyst insert for use in such a reactor, the catalyst insert comprising a plurality of foils bonded together and which define a multiplicity of flow sub-channels. In particular at least one end portion of the catalyst insert may be devoid of active catalytic material. In each aspect of the invention the reactor itself provides the structure and strength to withstand the stresses experienced during operation. Hence in each case the catalyst insert may be non-structural, as it does not have to hold the walls of the channel apart during operation. It may therefore be made of thin metal foil.

The invention will now be further and more particularly described, by way of example only, and with reference to the accompanying drawings, in which:

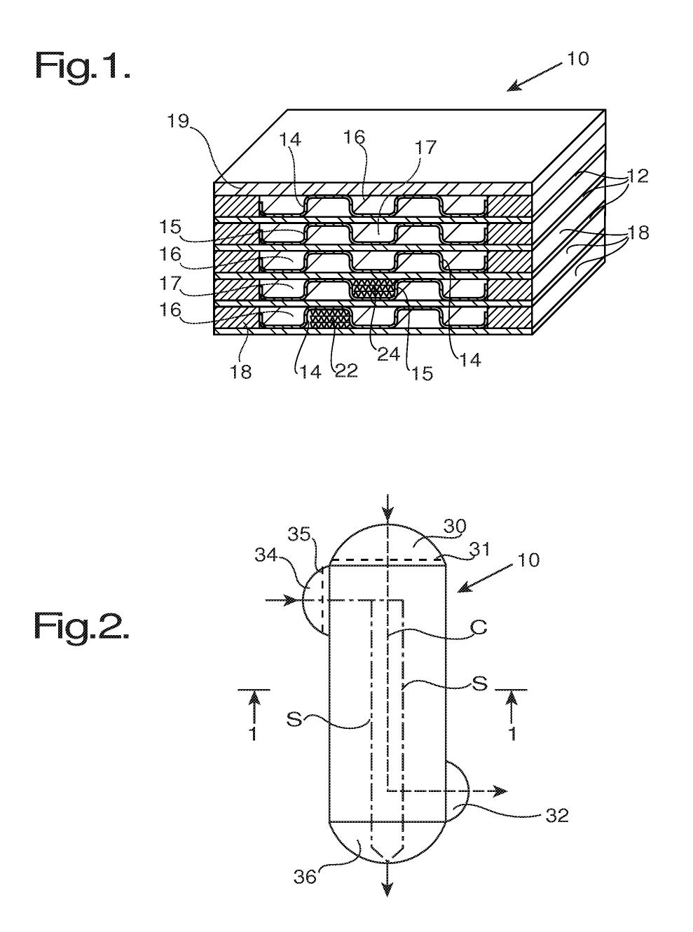

FIG. 1 shows a schematic perspective view, partly in section, of part of a reactor block suitable for steam/methane reforming and including catalyst inserts (the section being on the line 1-1 of FIG. 2);

FIG. 2 shows a side view of the assembled reactor block of FIG. 1 showing the flow paths;

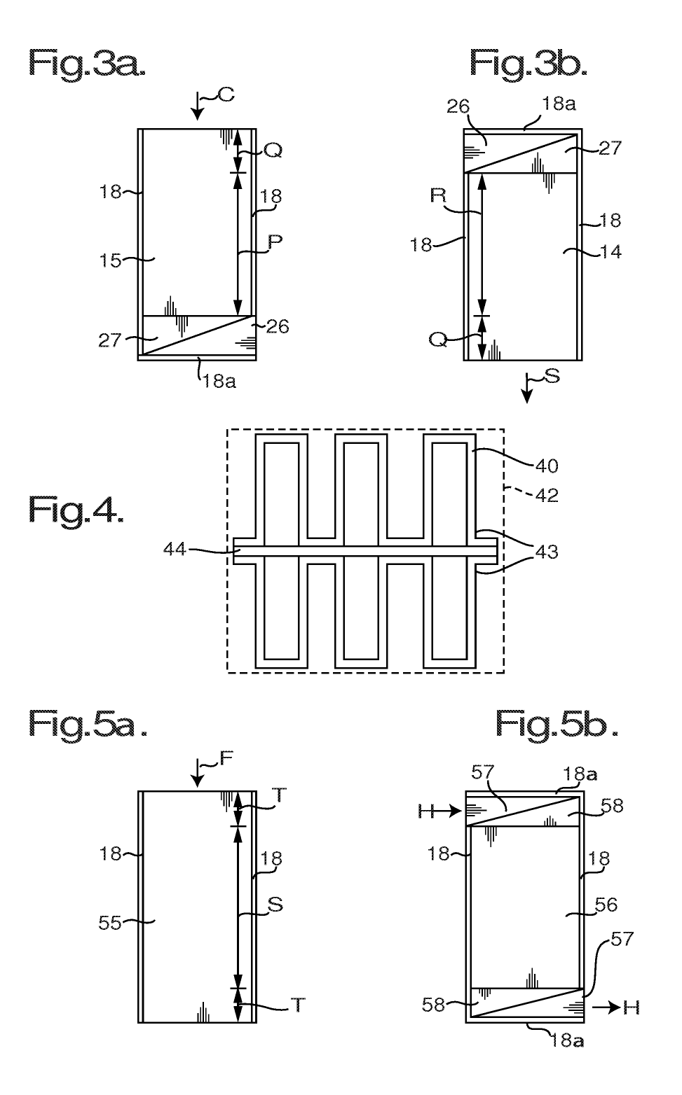

FIGS. 3a and 3b show plan views of parts of the reactor block of FIG. 1 during assembly;

FIG. 4 shows a sectional view of an alternative catalyst insert; and

FIGS. 5a and 5b show plan views of parts of an alternative reactor block during assembly.

The invention is applicable to many different chemical processes, and for example would be applicable to a process for making synthesis gas, that is to say a mixture of carbon monoxide and hydrogen, from natural gas by steam reforming. The synthesis gas may, for example, subsequently be used to make longer-chain hydrocarbons by a Fischer-Tropsch synthesis. The steam reforming reaction is brought about by mixing steam and methane, and contacting the mixture with a suitable catalyst at an elevated temperature so the steam and methane react to form carbon monoxide and hydrogen. The steam reforming reaction is endothermic, and the heat may be provided by catalytic combustion, for example of hydrocarbons and/or hydrogen mixed with air, so combustion takes place over a combustion catalyst within adjacent flow channels within the reforming reactor.

Referring now to FIG. 1 there is shown a reactor block 10 suitable for use as a steam reforming reactor, or for use in a steam reforming reactor. The reactor block 10 defines channels for a catalytic combustion process and channels for steam methane reforming. The reactor 10 consists of a stack of plates that are rectangular in plan view, each plate being of corrosion resistant high-temperature alloy such as Inconel 625, Incoloy 800HT or Haynes HR-120. Flat plates 12, typically of thickness in the range 0.5 to 4 mm, in this case 2.0 mm thick, are arranged alternately with castellated plates 14 or 15, so the castellations define channels 16 or 17. The castellated plates 14 and 15 are arranged in the stack alternately. The thickness of the castellated plates 14 and 15, typically in the range between 0.2 and 3.5 mm, is in each case 0.9 mm. The height of the castellations, typically in the range 2-10 mm, is 6.0 mm in each case, and solid bars 18 are provided along the sides. The wavelengths of the castellations in the castellated plates 14 and 15 may be different from each other, but as shown in the figure in a preferred embodiment the wavelengths are the same, so that in each case successive fins or ligaments are 7.0 mm apart. The castellated plates 14 and 15 may be referred to as fin structures. At each end of the stack is a flat end plate 19, which may also be of thickness 2.0 mm.

Although only five channels are shown as being defined by each castellated sheet 14 or 15 in FIG. 1, in a practical reactor there might be many more, for example over seventy channels in a reactor block 10 of overall width about 500 mm.

The stack of plates would be assembled and bonded together typically by diffusion bonding, brazing, or hot isostatic pressing. Into each of the channels 16 and 17 is then inserted a respective catalyst insert 22 or 24 (only one of each are shown in FIG. 1), carrying a catalyst for the respective reaction. These inserts 22 and 24 comprise a metal substrate and a ceramic coating acting as a support for the active catalytic material. The metal substrate of each insert 22, 24 comprises a stack of corrugated foils and flat foils occupying the respective flow channel 16 or 17, each foil being of thickness less than 0.2 mm, for example 50 microns or 100 microns; the stacks shown in FIG. 1 consist of three corrugated foils separated by two flat foils, bonded together. The catalyst inserts 22 and 24 occupy the channels 16 and 17, and the inserts are 5.4 mm high and 6.6 mm wide, these dimensions allowing sufficient clearance to accommodate tolerances in the channel sizes.

Referring now to FIG. 2 there is shown a side view of the assembled reactor block 10. The gas mixture undergoing combustion enters a header 30 at one end of the reactor block 10 (top, as shown) and after passing through a baffle plate flame arrestor 31 follows the flow channels 17 that extend straight along most of the length of the reactor 10. Towards the other end of the reactor block 10 the flow channels 17 change direction through 90° to connect to a header 32 at the side of the other end of the reactor 10 (bottom right as shown), this flow path being shown as a broken line C. The gas mixture that is to undergo the steam methane reforming reaction enters a header 34 at the side of the one end of the reactor block 10 (top left, as shown), passes through a baffle plate 35 and then changes direction through 90° to flow through the flow channels 16 that extend straight along most of the length of the reactor block 10, to emerge through a header 36 at the other end (bottom, as shown), this flow path being shown as a chain dotted line S. The arrangement is therefore such that the flows are co-current; and is such that each of the flow channels 16 and 17 is straight along most of it length, and communicates with a header 30 or 36 at an end of the reactor block 10, so that the catalyst inserts 22 and 24 can be readily inserted before the headers 30 or 36 are attached.

Each of the flat plates 12 shown in FIG. 1 is, in this example, of dimensions 500 mm wide and 1.0 m long, and that is consequently the cross-sectional area of the reactor block 10. Referring now to FIG. 3a there is shown a plan view of a portion of the reactor block 10 during assembly, showing the castellated plate 15 (this view being in a plane parallel to that of the view of FIG. 2). The castellated plate 15 is of length 800 mm, and of width 460 mm, and the side bars 18 are of width 20 mm. The top end of the castellated plate 15 is aligned with the top edge of the flat plate 12, so it is open (to communicate with the header 30). One of the side bars 18 (the left one as shown) is 1.0 m long, and is joined to an equivalent end bar 18a that extends across the end. There is consequently a 180 mm wide gap at the bottom right-hand corner (to communicate with the header 32). The rectangular region between the bottom end of the castellated plate 15 and the end bar 18a is occupied by two triangular portions 26 and 27 of castellated plate: a first portion 26 has castellations parallel to the end bar 18a, and extends to the edge of the stack (so as to communicate with the header 32), whereas the second portion 27 has castellations parallel to those in the castellated plate 15.

Referring to FIG. 3b there is shown a view, equivalent to that of FIG. 3a, but showing a castellated plate 14. In this case the castellated plate 14 is again of length 800 mm, and of width 460 mm, and the side bars 18 are of width 20 mm. The bottom end of the castellated plate 14 is aligned with the bottom edge of the flat plate 12, so it is open (to communicate with the header 36). One of the side bars 18 (the right one as shown) is 1.0 m long, and is joined to an equivalent end bar 18a that extends across the end. There is consequently a 180 mm wide gap at the top left-hand corner (to communicate with the header 34). In the rectangular region between the top end of the castellated plate 14 and the end bar 18a there are triangular portions 26 and 27 of castellated plate: a first portion 26 has castellations parallel to the end bar 18a, and extends to the edge of the stack (so as to communicate with the header 34), while the other portion 27 has castellations parallel to those in the castellated plate 14.

It will be appreciated that many other arrangements of portions of castellated plates may be used to achieve this change of gas flow direction. For example the castellated plate 15 and the portion of castellated plate 27 may be integral with each other, as they have identical and parallel castellations; and similarly the castellated plate 14 and the adjacent portion of castellated plate 27 may be integral with each other. Preferably the castellations on the triangular portions 26 and 27 have the same shape as those on the channel-defining portions 14 or 15. In some cases the triangular portions 26 and 27 may be omitted, to leave a gas distribution space between the flat plates 12 through which the gas flows between the end of the castellated plate 14 or 15 and the header 32, 34 at the side of the block 10.

As mentioned previously, after the stack of plates 12, 14, 15 has been assembled, catalyst inserts 22 and 24 are inserted into the reaction channels 16 and 17. The catalyst inserts 24 are of length 800 mm and incorporate active catalytic material along 600 mm of their length, corresponding to the bottom three-quarters of the straight channels as shown in plan in FIG. 3a, this portion being indicated by the arrow P, and over the other 200 mm indicated by the arrow Q the inserts 24 are non-catalytic. Similarly in the channels 16 for the steam reforming gas mixture S the catalyst inserts 22 are of length 800 mm, and as indicated by the arrow R active catalytic material is provided along the portion occupying the upper three-quarters of the straight channels as shown in plan in FIG. 3b; the other 200 mm of the length of the inserts 22 as indicated by the arrow Q are non-catalytic. After inserting the catalyst inserts 22 and 24, a wire mesh (not shown) may be attached across the bottom end of the reactor block 10 so that the catalyst inserts 22 do not fall out of the flow channels 16 when the reactor block 10 is in its upright position (as shown in FIG. 2). It will hence be appreciated that the active catalytic materials on the inserts 22 and 24 are only present in those portions P and R of the flow channels 16 and 17 which are immediately adjacent to each other.

It will be appreciated that headers 30, 32, 34 and 36 might then be attached to the reactor block 10. Alternatively it may be more convenient to provide a reactor of larger capacity, and this may be achieved by combining several such reactor blocks 10 together, before attaching headers.

As indicated above the inserts 22 and 24 comprise a metal substrate and a ceramic coating acting as a catalyst support. The metal substrate of each insert 22, 24 comprises a stacked assembly of corrugated foils and flat foils occupying the respective flow channel 16 or 17, each foil being of thickness less than 0.2 mm, for example 50 microns or 100 microns; those of FIG. 1 consist of three corrugated foils separated by two flat foils, bonded together. The total length of each insert 22 and 24 is 800 mm. All the foils may be of the desired length, 800 mm in this example. Alternatively, the flat foils may be of the desired length, whereas the corrugated foils are made up of shorter lengths placed end to end. The assembly is stacked and bonded to form an integral structure, in which each length of foil is bonded to the successive length of foil in the stack. As a further alternative example each flat foil in the stack is made up of four lengths of flat foil, of lengths 100 mm, 300 mm, 300 mm and 100 mm, arranged end to end; while each corrugated foil is made up of three lengths of corrugated foil with corrugations running along their length, of lengths 300 mm, 300 mm and 200 mm, arranged end to end. This ensures that the positions in successive layers of the stack where the lengths of foil meet are staggered. This approach is based on the availability of foils of length up to 300 mm of the desired metal alloy. If 400 mm long foils are available, for example, a 800 mm long insert might comprise corrugated foils of length 400 mm placed end to end, stacked with flat foils of lengths say 200 mm, 400 mm and 200 mm. In a preferred manufacturing technique such an assembly is stacked and bonded together using foils that are considerably wider than required, for example 500 mm or 1000 mm wide; the assembly is then cut into strips of the appropriate width for the channels 16, 17, which in this case is 6.6 mm. This may use laser cutting.

After bonding the foils together, and either before or after cutting into channel-sized strips, the catalyst is provided. This may be provided by impregnating the active metal into an alumina or ceramic support which is then formed into a washcoat into which the foils are dipped. Alternatively, a ceramic coating may be deposited, for example by dip coating into a slurry containing alumina, the coating dried and fired, and then the coating is impregnated with catalytically active material corresponding to the reaction that is required. Typically the catalytically active material will be introduced in the form of a salt, which is then calcined and if necessary reduced to provide the active form of the material. A portion of each stacked assembly is not provided with the ceramic coating or the catalytically active material, this being a portion of length 200 mm at one end. Consequently each of the inserts 22 and 24 has a non-catalytic portion of length 200 mm at one end, corresponding to the portions Q indicated in FIGS. 3a and 3b.

It will be appreciated that the catalyst inserts 22 and 24 described above are by way of example only. The corrugated foils of the inserts 22 and 24 are shown as having triangular or zigzag-shaped corrugations, but it will be appreciated that the corrugations may have other shapes. The corrugations in successive corrugated foils may be lined up with each other, peak above peak, or peak above trough, i.e. with the corrugations being in phase or in anti-phase; or the phase relationship between corrugations in successive corrugated foils may be random. The inserts 22 and 24 are shown as comprising three corrugated foils separated by two flat foils, but other combinations are possible, for example four substantially flat foils might be separated by three corrugated foils to form catalyst inserts with flat foils as the outermost components. As a further modification the catalyst inserts, at least those in the flow channels 16 for the steam methane reforming reaction might be slightly longer than the channels, for example being 805 mm long, and in this case the non-catalytic portion would be 205 mm long. A short portion of the catalyst insert would therefore project beyond the bottom end of the reactor, which would simplify removal when the catalyst is spent.

Referring now to FIG. 4 there is shown a cross-sectional view through a catalyst insert 40 for use in a flow channel 42 (indicated by a broken line). This catalyst insert 40 consists of two corrugated foils 43 formed into rectangular castellations so as to define sub-channels 2.5 mm high and 1.1 mm wide, these foils 43 being bonded to opposite faces of a flat foil 44 of thickness 0.1 mm. In this case the castellations in the two foils 43 are lined up with each other in anti-phase, with peaks in one foil 43 lining up with troughs in the other foil 43. As described above in relation to the inserts 22 and 24, this insert 40 may be made by first preparing an assembly stacked and bonded together of foils that are considerably wider than required, for example 500 mm or 1000 mm wide; the assembly is then cut into strips of the appropriate width for the channels 42. This may use laser cutting, mechanical cutting or other similar techniques.

After bonding the foils together, and either before or after cutting into channel-sized strips, the ceramic coating and the active catalytic material would be deposited as previously described. A portion of each stacked foil assembly is not provided with the ceramic coating or the catalytically active material, this being a portion of length 200 mm at one end. Consequently the insert 40 has a non-catalytic portion of length 200 mm at one end. The catalyst insert 40 is inserted into a channel 42 in a reactor block analogous to that described above. The peaks and troughs of the rectangular castellations provide a large area in proximity to the channel walls at the top and bottom, so enhancing heat transfer; and the intervening portions of the castellations extend parallel to the direction of heat transfer, which also enhances heat transfer. It will be appreciated that the catalyst insert 40 is shown by way of example only, and that a modification might for example comprise three foils corrugated into rectangular castellations and separated by two flat foils.

The provision of catalyst inserts 22, 24 or 40 that incorporate a non-catalytic length simplifies assembly of the reactor, as each channel 16 or 17 merely has to accommodate one such insert. The arrangement of the catalytic material on the inserts ensures that the catalytic material is provided only along those portions of the flow channels where the flows are parallel and co-current in adjacent flow channels, corresponding to sections P and R shown in FIGS. 3a and 3b, which improves the temperature distribution within the reactor. In the reactor block 10 described above, each flow path C and S is L-shaped, with a straight section communicating directly with a header 30 or 36 at one end of the block, and a distributor section linking to a header 32 or 34 at one side of the block. Chemical reactions take place in both sets of channels, and therefore catalyst inserts 22, 24 are inserted into the straight sections.

The concept of the present invention is equally applicable in reactors for other chemical reactions. By way of example, a similar reactor may be used for a reaction such as Fischer-Tropsch synthesis, in which a chemical reaction takes place in one set of channels while a heat transfer medium flows in an adjacent set of channels. In this case no chemical reaction takes place in the channels carrying the heat transfer medium, so no catalyst insert is required in those channels. Consequently the channels for the chemical reaction may extend straight through the reactor block from one end to the other, while the channels for the heat transfer medium may incorporate a central section that is parallel to the channels for the chemical reaction, and a distributor section at each end to link to headers at the side or sides of the block.

Such a reactor is shown in FIGS. 5a and 5b, to which reference is now made. In FIG. 5a there is shown a plan view of a portion of a reactor block for Fischer-Tropsch reactions during assembly. As in the reactor block 10 described above, the reactor block for the Fischer-Tropsch reaction consists of a stack of flat plates and castellated plates. The plates may be of a high temperature alloy, as described above, but since reaction temperatures are lower the plates may instead be of other materials such as stainless steel or an aluminium alloy. The flat plates, in this example, are of dimensions 500 mm wide and 1.0 m long, and that is consequently the cross-sectional area of the reactor block. FIG. 5a shows a castellated plate 55 that defines flow channels for the Fischer-Tropsch reactants, F. The castellated plate 55 is of length 1000 mm, and of width 460 mm, and along each side are side bars 18 of width 20 mm. The top and bottom ends of the castellated plate 55 are aligned with the top and bottom edges of the adjacent flat plates, so the channels defined by the plate 55 are open at each end.

Referring to FIG. 5b there is shown a view, equivalent to that of FIG. 5a, but showing a castellated plate 56 which defines flow channels for a coolant. Such castellated plates 56 are arranged alternately in the stack with the castellated plates 55, separated by flat plates. In this case the castellated plate 56 is of length 800 mm, and of width 460 mm, and the side bars 18 are of width 20 mm. Each side bar 18 is of length 900 mm, and is joined to an equivalent end bar 18a that extends across the end. There are consequently 80 mm wide gaps at the top left and bottom right corners through which a coolant flows in and out respectively, as indicated by arrows H. In the rectangular regions between the ends of the castellated plate 56 and the end bars 18a there are triangular portions 57 and 58 of castellated plate: a first portion 57 has castellations parallel to the end bar 18a, and extends to the edge of the stack so as to communicate with a header (not shown), while the other portion 58 has castellations parallel to those in the castellated plate 56.

Catalyst inserts are provided in the channels defined in the castellated plate 55 and carry a catalyst for the Fischer-Tropsch reaction. These catalyst inserts extend the entire length of each channel, that is to say 1000 mm, but catalytic material is provided only on the central 800 mm section marked S, so there are non-catalytic portions T of length 100 mm at each end. Hence the catalyst portions S are adjacent to portions of the coolant channels in which the coolant flow is parallel to the flow in the reaction channels.

It will be appreciated that the reactor block described in relation to FIGS. 5a and 5b is by way of example only. For example a reactor block may have a length or a width different to that described above.

1. A reactor defining first and second flow channels within the reactor, the first flow channels and the second flow channels extending in parallel directions along at least the major part of their lengths, with a removable catalyst insert provided in those channels in which a reaction is to occur, each catalyst insert comprising a plurality of foils bonded together and which subdivide the flow channel into a multiplicity of flow sub-channels, wherein at least one end portion of each catalyst insert is devoid of active catalytic material and wherein catalyst inserts in at least one set of flow channels are slightly longer than the length of those flow channels, so as to protrude from an end of the flow channel.

2. A reactor as claimed in claim 1 wherein the first or second flow channels include inlet or outlet portions that connect to an inlet or outlet port or to a header, and extend in a direction that is not parallel to the direction of the major part of the length of the flow channel.

3. A reactor as claimed in claim 2 wherein active catalytic material is provided only on those portions of the catalyst insert that locate in a region of the reactor in which the first and second flow channels extend in parallel directions.

4. (canceled)

5. A reactor as claimed in claim 1 wherein the protruding length is no more than 20 mm, preferably no more than 10 mm.

6. A reactor as claimed in claim 1 wherein each catalyst insert comprises a stack of foils at least some of which are corrugated, each layer of the stack comprising lengths of foil arranged end to end, wherein in successive layers the positions at which ends of foils meet are staggered.

7. A reactor as claimed in claim 1, wherein each catalyst insert comprises a stack of foils at least one of which is substantially flat and at least one is corrugated, and wherein the flat foils are of the same length as the insert and wherein the corrugated foils in the stack comprise a plurality of corrugated lengths of foil arranged end to end.

8. A reactor as claimed in claim 1 wherein at least some of the foils are corrugated, and the foils are bonded together along the entire length of each peak of the corrugations.

9. A reactor as claimed in claim 1 wherein the length of the catalyst insert that is devoid of active catalytic material is no more than 30% of the total length of the catalyst insert, preferably no more than 25%.

10. A reactor as claimed in claim 1 wherein the catalyst insert comprises an assembly of corrugated foils and substantially flat foils that are arranged alternately in a stack and bonded together.

11. A reactor as claimed in claim 1 wherein some of the foils that constitute the catalyst insert are devoid of catalyst along their length.

12. A reactor as claimed in claim 1 wherein some sub-channels are devoid of catalyst along their length.

13. A reactor defining first and second flow channels within the reactor, with a removable non-structural catalyst insert provided in those channels in which a reaction is to occur, the catalyst insert comprising a plurality of foils bonded together and which subdivide the flow channel into a multiplicity of flow sub-channels, wherein each catalyst insert comprises a stack of foils at least some of which are corrugated, and wherein at least some of the layers of the stack comprise lengths of foil arranged end to end.

14. A reactor as claimed in claim 13, wherein in the stack there are adjacent layers each comprising lengths of foil arranged end to end, and the positions at which ends of foils meet in those adjacent layers are staggered.

15. A catalyst insert for use in a reactor as claimed in claim 1, the catalyst insert comprising a plurality of foils bonded together and which define a multiplicity of flow sub-channels.

16. A reactor defining first and second flow channels within the reactor, the first flow channels and the second flow channels extending in parallel directions along at least the major part of their lengths, with a removable catalyst insert provided in those channels in which a reaction is to occur, each catalyst insert comprising a plurality of foils bonded together and which subdivide the flow channel into a multiplicity of flow sub-channels, wherein at least one end portion of each catalyst insert is devoid of active catalytic material and wherein each catalyst insert comprises a stack of foils at least some of which are corrugated, each layer of the stack comprising lengths of foil arranged end to end, wherein in successive layers the positions at which ends of foils meet are staggered.

17. A reactor as claimed in claim 16 wherein active catalytic material is provided only on those portions of the catalyst insert that locate in a region of the reactor in which the first and second flow channels extend in parallel directions.

18. A reactor as claimed in claim 16 wherein the catalyst insert comprises an assembly of corrugated foils and substantially flat foils that are arranged alternately in a stack and bonded together.

19. A reactor as claimed in claim 16 wherein some of the foils that constitute the catalyst insert are devoid of catalyst along their length.

20. A reactor as claimed in claim 16 wherein the catalyst insert comprises an assembly of corrugated foils and substantially flat foils that are arranged alternately in a stack and bonded together, the flat foils being of the same length as the insert and the corrugated foils in the stack comprising a plurality of corrugated lengths of foil arranged end to end.

21. A catalyst insert for use in a reactor as claimed in claim 16, the catalyst insert comprising a plurality of foils bonded together and which define a multiplicity of flow sub-channels.
